(19) United States
(12) Patent Application Publication
(10) Pub. No.: US 2004/0140895 A1
(43) Pub. Date: Jul. 22, 2004

(54) Mailbox and notification device

(76) Inventor: Dexter N. Jordan, Suitland, MD (US)

Correspondence Address: Richard C. Litman, LITMAN LAW OFFICES, LTD., P.O. Box 15035, Arlington, VA, 22215, US

(21) Appl. No.: 10/750,849

(22) Filed: Jan. 5, 2004

Related U.S. Application Data
(60) Provisional application No. 60/438,517, filed on Jan. 8, 2003.

(51) Int. Cl. G08B 13/14

(52) U.S. Cl. 340/569

(57) ABSTRACT

An individual rural-type mailbox and notification device. The device has a generally hollow cylindrical body with a flat bottom, a hinged front door on the front end of the generally hollow cylindrical body and a solid wall backing on the back end of the generally hollow cylindrical body. An intermittently blinking LED light on the hinged front door that is visible from the front of the generally hollow cylindrical body and an intermittently blinking LED light on the solid wall backing, that is visible from the back of the generally hollow cylindrical body, is also included. There is also a second embodiment of this invention, which is a lockbox-type mailbox and notification device with similar features.

### CROSS-REFERENCE TO RELATED APPLICATION

This application claims the benefit of U.S. Provisional Patent Application Serial No. 60/438,517, filed Jan. 8, 2003.

### BACKGROUND OF THE INVENTION

1. Field of the Invention

The present invention relates to mailbox and notification devices. More particularly, these types of mailboxes and notification devices are for individual rural-type mailboxes and lockbox-type mailboxes.

2. Description of Related Art

Mailbox notification devices are very useful products and have been in the related art for approximately the last 20 years. They provide a valuable service in allowing users to know when they have mail in their mailboxes, so persons can make arrangements to pick-up their mail, knowing that there actually is mail in their mailbox. Mailbox notification systems can also be tied into modern technological devices. Some of these advances are reflected in the related art.

U.S. Patent Application Publication 2002/0024438 by Roberson published on Feb. 28, 2002, outlines the use of a method and system designed to allow a user to determine the mail status of a mailbox without having to go to the mailbox. Using the Internet, a telephone, a cell telephone, a computer, a computer with a Web site, a television Web site, or a special transmitter and receiver, a person can receive information about the status of their mailbox (if the mailbox contains any mail) regardless of the distance of the user from the mailbox.

U.S. Patent Application Publication 2002/0067262 by Lie published on June 6; 2002, outlines the use of a device for detecting and signaling or indicating status as regards to contents in a container, and in particular to a letterbox. The device is made-up of a detector for registering a change of state in the letterbox, which is transmitted to and activates a preferably remote display, or the like, in order to produce on the display a visual and/or audible message, which signals that contents have been deposited in the letterbox.

U.S. Patent Application Publication 2002/0103868 by Khan published on Aug. 1, 2002, outlines the use of a method for enabling a user of a mail receptacle to remotely receive information relating to the content, if any, of such a mail receptacle and includes the steps of generating status information for the mail receptacle, the status information including information indicating whether the mail receptacle contains one or more mail items, storing the status information in a computer system and providing the status information to the user via the computer system. The user can determine from a location spatially remote from the mail receptacle, whether the mail receptacle contains the one or more mail items.

U.S. Patent Application Publication 2002/0113703 by Moskowitz et al., outlines the use of a system, method, apparatus and computer program code for notifying at least one entity upon receipt of an item. According to embodiments of the present invention, a determination is made whether an item has been placed in a repository. This determination may be made using any number of different types and combination of sensors. An identification of at least one entity to be notified, is made and the entity is notified if a determination is made that an item has been placed in the repository.

U.S. Patent Application Publication 2002/0121543 by Simmons published on Sep. 5, 2002, outlines the use of a rural type mailbox having a transparent window formed through the front rear of a preferred embodiment. A slide transparent window is provided to access the interior from the side of the mailbox to remove or enter mail when desired. There is a mail-in-box indicator LED to let the user know when mail has arrived, with the LED's illumination inside of the mailbox, to see in at night, using a remote control and having a solar panel for rechargeable batteries.

U.S. Pat. No. 4,314,102 issued to Lowe et al. on Feb. 2, 1982, outlines the use of a system for detecting the presence of mail in a post office box. A post office box holder calls a telephone number, which accesses a computer. The computer contains data representative for the presence or absence of letters in a plurality of post office boxes. If the box to which the caller refers is occupied, a series of tone pulses is transmitted to the caller by a tone generator under the direction of the computer.

U.S. Pat. No. 4,633,236 issued to Buhl on Dec. 30, 1986, outlines the use of a mailbox including an indicator indicating the presence of mail, if any, and including a detector having a transmitting and receiving ultrasonic transducer. The transducer transmits ultrasonic waves into the mailbox and based on the received ultrasonic waves, indicates alterations in the reflected energy. In this manner, mail in the mailbox is detected even if the mail does not take-up much room in the mailbox.

U.S. Pat. No. 4,794,377 issued to Benages on Dec. 27, 1988, outlines the use of a signal to indicate a deposit of mail in a box remote from a residence, which employs an optical reflective detector, which senses the presence of mail in the box. The transmission may be radio frequency if the box is relatively isolated from other boxes. In apartments, condominiums and the like where multiple boxes are centrally located, transmission may be by special wiring or by imposing a coded signal on the electrical system of a house.

U.S. Pat. No. 5,239,305 issued to Murphy et al. on Aug. 24, 1993, outlines the use of a system for indicating the deposit of mail in a mailbox that is made-up of a two channel transmitter positioned within a mailbox and a two channel receiver positioned within a household. The first channel of the system provides a way for indicating at the receiver, the opening of the mailbox door and the second channel of the system provides a way for resetting the indication for a deposit of mail.

U.S. Pat. No. 5,377,906 issued to Mason on Jan. 3, 1995, outlines the use of a device for detecting and signaling the presence of an object in a closed container. The closed container is a mailbox having a housing, with one or more sensors having an electronic circuit having a detector and an optical signal trigger, with one or more sensors coupled to the housing. There is also an optical signal electrically connected to the optical signal trigger. The device provides an electric mailbox, which allows an observer to detect the presence of mail from a remote location.

U.S. Pat. No. 5,440,294 issued to Mercier et al. on Aug. 8, 1995, outlines the use of a system for remotely sensing the delivery of mail to a mailbox that uses a transmitter mounted on the mailbox. The transmitter generates a prescribed signal when the door of the mailbox is opened. The system also uses a receiver adapted for placement at a location remote from the transmitter.

Although each of the devices outlined in these patents are useful and novel, what is really needed is a mailbox notification device that has a shutoff timing mechanism after being activated after a certain point in time. Such a device would be quite valuable to current mailbox device users shopping in today's marketplace.

None of the above inventions and patents, taken either singly or in combination, is seen to describe the instant invention as claimed.

### SUMMARY OF THE INVENTION

The invention is an individual rural-type mailbox and notification device. The device has a generally hollow cylindrical body with a flat bottom, a hinged front door on the front end of the generally hollow cylindrical body and a solid wall backing on the back end of the generally hollow cylindrical body. An intermittently blinking LED light is on the hinged front door that is visible from the front of the generally hollow cylindrical body and an intermittently blinking LED light is on the solid wall backing, that is visible from the back of the generally hollow cylindrical body, is also included. There is also a second embodiment of this invention, which is a lockbox-type mailbox and notification device with similar features.

Accordingly, it is a principal object of the invention to provide a mailbox and notification system with a shutoff timing mechanism that can shut itself off after being activated after a certain period of time.

It is another object of the invention to provide an individual rural-type mailbox that can notify users from both the front and the back of the mailbox.

It is a further object of the invention to provide a mailbox and notification device for individual rural-type mailboxes and groups of lockbox-type mailboxes.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental perspective view of the first embodiment of a mailbox and notification device according to the present invention.

FIG. 2 is a front side perspective view of the first embodiment of a mailbox and notification device.

FIG. 3 is a side perspective view of the second embodiment of a mailbox and notification device.

FIG. 4 is a block diagram of notification types for both the first and second embodiments of a mailbox and notification device.

Similar reference characters denote corresponding features consistently throughout the attached drawings.

### DETAILED DESCRIPTION OF THE PREFERRED EMBODIMENTS

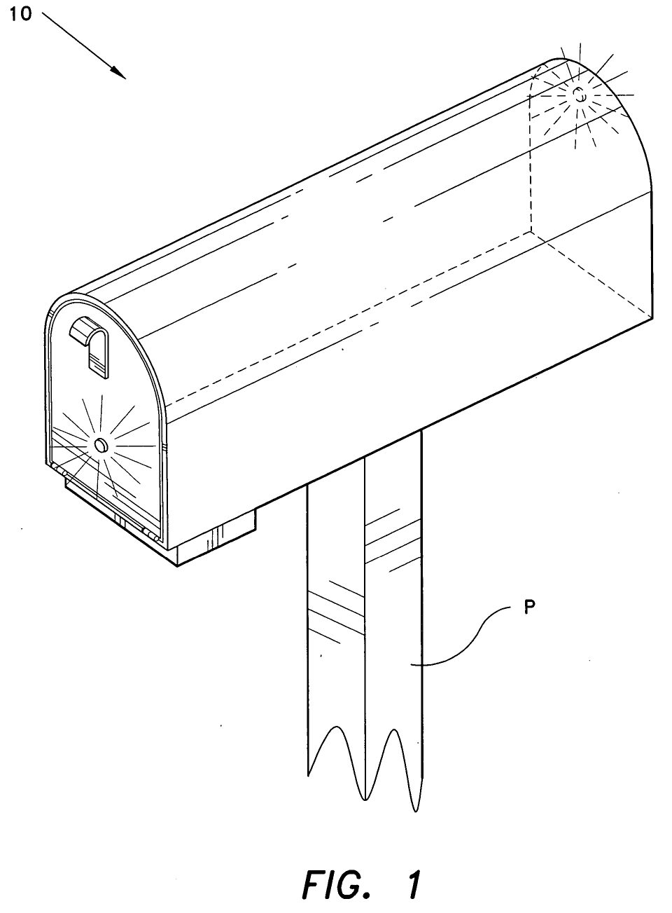

The present invention is an individual rural-type mailbox and notification device 10, which can be used with a post P, as is shown in FIG. 1.

The individual rural-type mailbox and notification device 10 comprises a generally hollow cylindrical body 20, with a front end 22 and a back end 24, for receiving and containing mail, the generally hollow cylindrical body 20 having a flat bottom 30, a hinged front door 40 on the front end 22 and a solid wall backing 50 on the back end 24 of the generally hollow cylindrical body 20. The individual rural-type mailbox and notification device 10 further includes the flat bottom 30 having a contact strip 60 that covers a portion of the entire exposed surface of the flat bottom 30, with the hinged front door 40 being manually opened to place mail into or to take mail out of the generally hollow cylindrical body 20.

There is also an LED light 70 on the hinged front door 40 that is visible from the front end 22 of the generally hollow cylindrical body 20 and an LED light 80 on the solid wall backing 50, that is visible from the back end 24 of the generally hollow cylindrical body 20. Both the LED light 70 on the hinged front door 40 and the LED light 80 on the solid wall backing 50 indicate the presence of mail by the use of the intermittently blinking LED lights. There is also a power source 90 to supply power to the individual rural-type mailbox and notification device 10. The presence of an LED light 80 on the solid wall backing 50 is a point of novelty of the individual rural-type mailbox and notification device 10 in comparison with the related art, which do not show an LED light on the back of a mailbox.

This LED light 80 on the solid wall backing 50 enables a user to see from the back end 24 of the individual rural-type mailbox and notification device 10, if he or she has any mail. This is an improvement, since most similar devices in the related art notify users from the front end 22, as opposed to both the front end 22 and the back end 24 of the individual rural-type mailbox and notification device 10. The activation of the individual rural-type mailbox and notification device 10 is simple, wherein the generally hollow cylindrical body 20 receives a physically inserted piece of mail, which activates the contact strip 60, which is electronically integral to the LED lights 70,80 and the power source 90.

The individual rural-type mailbox and notification device 10 also includes an 8 hour timing device 105 that utilizes blinking LED lights 70,80 to indicate that mail is present in the individual rural-type mailbox and notification device 10. The 8 hour timing device 105 will continue to blink up to 8 hours, upon which it will automatically shut-off.

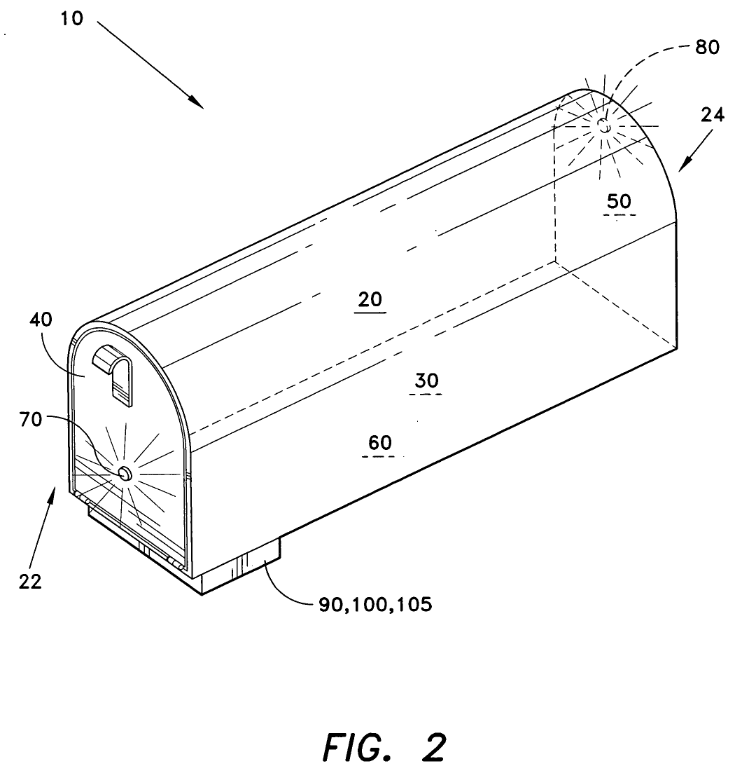

The individual rural-type mailbox and notification device 10 utilizes a portable battery 100 as it's the power source 90, although other well-known power sources 90 can also be used, such as a standard electrical outlet. The individual rural-type mailbox and notification device 10 is made of sheet metal or thermoplastic. These features of the individual rural-type mailbox and notification device 10 are depicted in FIG. 2 and are the first embodiment of this invention.

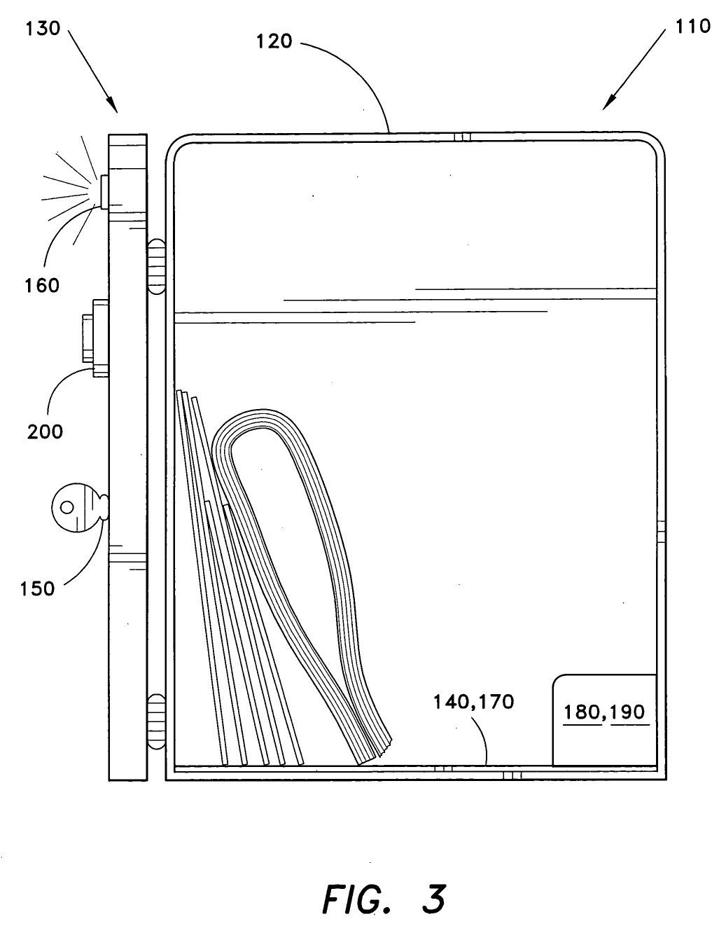

FIG. 3 illustrates the features of the second embodiment of this invention, which is a lockbox-type mailbox and notification device 110. The lockbox-type mailbox and notification device 110 comprises a generally rectangular hollow body 120, with a front-hinged door 130, and a flat bottom 140. The front-hinged door 130 has a lock and key arrangement 150 to secure mail held in the generally rectangular hollow body 120. There is also an LED light 160 on the front-hinged door 130 to indicate to a user that there is mail present in the generally rectangular hollow body 120.

Like the individual rural-type mailbox and notification device 10, a contact strip 170 is provided that covers a portion of the exposed surface area of the flat bottom 140, as well as a power source 180 to supply power to the lockbox-type mailbox and notification device 110. Also like the individual rural-type mailbox and notification device 10, the power source 180 used by the lockbox-type mailbox and notification device 110 is a portable battery 190, although other power sources 180 can also be used if desired.

A point of novelty also with the lockbox-type mailbox and notification device 110 is the presence of a timing device 200 to shut-off an activated blinking LED light 160 after a specified period of time. The timing device 200 can shut-off an activated LED light 160 after as long as 8 hours. This will help to conserve energy from the power source by not letting the activated blinking LED light 160 run down for long periods of time.

The generally hollow rectangular body 120 of the lockbox-type mailbox and notification device 110 can receive a physically inserted piece of mail, which activates the contact strip 170, which is electronically integral to the LED lights 160 and the power source 180. The generally rectangular hollow body 120 and front-hinged door 130 are made of sheet metal. The lockbox-type mailbox and notification device 110 is typically stored adjacently with a plurality of other lockbox type mailbox and notification devices 110 in a grouping, such as in a large apartment building.

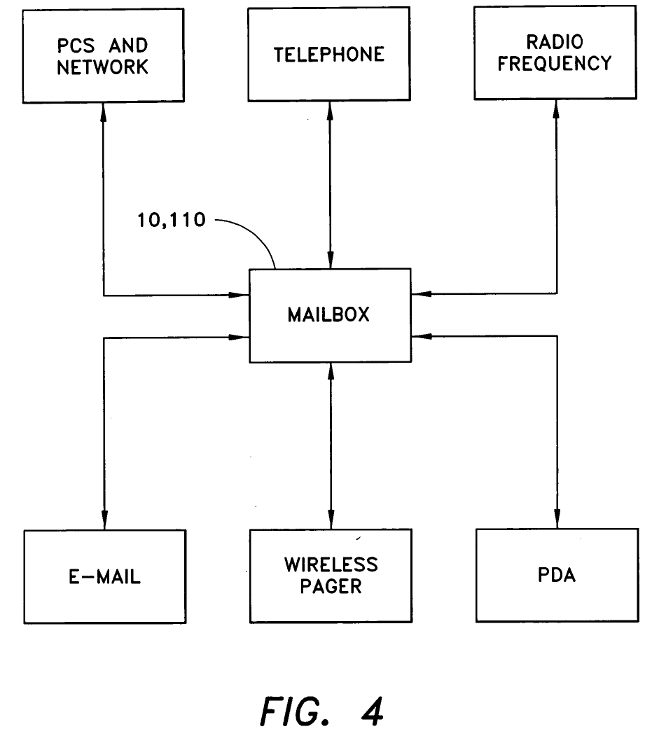

There are several notification types that can be utilized with both the individual rural-type mailbox and notification device 10 and the lockbox-type mailbox and notification device 110, as is shown in FIG. 4. These types of technology are all well-known to those schooled in the related art and include the implementation of PCs and network computers, telephones, radio frequency devices, e-mail, wireless pagers and personal digital assistants with the individual rural-type mailbox and notification device 10 and the lockbox-type mailbox and notification device 110.

It is to be understood that the present invention is not limited to the sole embodiments described above, but encompasses any and all embodiments within the scope of the following claims.

I claim:

1. An individual rural-type mailbox and notification device, comprising:
a generally hollow cylindrical body with a front end and a back end for receiving and containing mail, said generally hollow cylindrical body having a flat bottom, a hinged front door on the front end of the generally hollow cylindrical body and a solid wall backing on the back end of the generally hollow cylindrical body;
said flat bottom having a contact strip that covers a portion of the exposed surface of the flat bottom;
said hinged front door can be manually opened and must be opened to place mail into or to take mail out of the generally hollow cylindrical body;
an intermittently blinking LED light on the hinged front door that is visible from the front of the generally hollow cylindrical body and an intermittently blinking LED light on the solid wall backing, that is visible from the back of the generally hollow cylindrical body, to notify a user of the presence of mail;
a timing device that shuts-off the intermittently blinking LED lights for up to 8 hours; and
a power source to supply power to the individual rural-type mailbox and notification device.

2. The mailbox and notification device according to claim 1, wherein the generally hollow cylindrical body receives a physically inserted piece of mail, which activates the contact strip, which is electronically integral to the LED lights and the power source.

3. The mailbox and notification device according to claim 1, wherein the power source is a battery.

4. The mailbox and notification device according to claim 1, wherein the power source is an electrical outlet.

5. The mailbox and notification device according to claim 1, wherein the individual rural-type mailbox is made of sheet metal.

6. The mailbox and notification device according to claim 1, wherein the individual rural-type mailbox is made of a thermoplastic material.

7. A lockbox-type mailbox and notification device, comprising:
a generally rectangular hollow body with a front-hinged door and a flat bottom, said front-hinged door has a lock and key arrangement to secure mail held in the generally rectangular hollow body;
an LED light on the front-hinged door to indicate to a user that there is mail present in the generally rectangular hollow body; and
a contact strip that covers a portion of the flat bottom and a power source to supply power to the lockbox-type mailbox and notification device; and
a timing device to shut-off an activated LED light after a specified period of time.

8. The mailbox and notification device according to claim 7, wherein the generally hollow cylindrical body receives a physically inserted piece of mail-, which activates the contact strip, which is electronically integral to the LED lights and the power source.

9. The mailbox and notification device according to claim 6, wherein the power source is a battery.

10. The mailbox and notification device according to claim 7, wherein the power source is an electrical outlet.

11. The mailbox and notification device according to claim 7, wherein the individual rural-type mailbox is made of sheet metal.

12. The mailbox and notification device according to claim 7, wherein the individual rural-type mailbox is made of a thermoplastic material.
